(19) United States
(12) Patent Application Publication
(10) Pub. No.: US 2002/0172190 A1
(43) Pub. Date: Nov. 21, 2002

(54) Method and apparatus for secure communication and key distribution in a telecommunication system

(76) Inventor: Harri Vatanen, Surrey (GB)

Correspondence Address: COHEN, PONTANI, LIEBERMAN & PAVANE, Suite 1210, 551 Fifth Avenue, New York, NY, 10176, US

(21) Appl. No.: 09/954,932

(22) Filed: Sep. 17, 2001

(30) Foreign Application Priority Data
Mar. 17, 1999 (FI) 990601
Mar. 17, 2000 (FI) PCT/FI00/00223

(51) Int. Cl. H04L 12/66; H04J 1/02

(52) U.S. Cl. 370/352; 370/493

(57) ABSTRACT

A method and system for secure routing of information and addressing of a service and of the parties to the service in a telecommunication system that includes a telecommunication terminal, a telecommunication network, a service provider connected to the telecommunication network, a service apparatus connected to the telecommunication network, and a communication link between the telecommunication terminal and the service apparatus. The service apparatus and/or the service indicated by the apparatus, and the telecommunication terminal, are each provided with an unambiguous identifier associated with predetermined encryption and/or digital signing keys. A given service apparatus is addressed by means of the telecommunication terminal by sensing a predetermined connection setup request from the telecommunication terminal to the service apparatus. The service provider's network address and/or other information relating to the selected service is sent from the telecommunication terminal to the service apparatus via the communication link, which may be based on Bluetooth technology.

### BACKGROUND OF THE INVENTION

1. Field of the Invention

The present invention relates to telecommunications and, in particular, is directed to methods and systems for secure routing of information and addressing of a service and of the parties to a service in a telecommunication system.

2. Description the Related Art

Mobile stations used in mobile communication networks, as for example a GSM (Global System for Mobile communications) network, have considerable advantages as compared with wired-network telephones. The most significant of those advantages is or course mobility, since the use of a mobile station is not dependent on location.

Traditionally, the main purpose of a telephone subscription and the associated terminal equipment has been to establish and maintain a speech connection between parties. The use of a mobile station is not, however, limited to the transmission of speech; rather, new uses and functionality are continuously being developed for mobile stations. Thus, a variety of services based on text messages have become very popular. The popularity of data services is also growing and will further grow as the data transmission speed of mobile stations is increased. Indeed, third-generation (so-called 3G) mobile telephones and their supporting telecommunication systems will be capable of real-time transmission of moving images.

A group of leading telecommunication and information technology enterprises have developed a technique that can be used to establish a wireless connection between a mobile station and, for example, a portable computer. This technique is implemented in a technology commonly identified by the moniker “Bluetooth”, and is based on short-range radio (i.e. wireless) technology which allows many types of terminal equipment to be readily interconnected. A more detailed description of Bluetooth technology and techniques can be found on the World Wide Web at www.bluetooth.com.

As noted above, Bluetooth technology accommodates the interconnection of different devices via a short-range radio link. Using this technology it is for example possible to establish a connection, without cumbersome cabling, between a mobile station and a portable computer. Printers, workstations, fax devices, keyboards and virtually any digital equipment may form a part or node of a Bluetooth system or network. This technology accordingly provides a universal bridge to existing data networks and peripherals and makes it possible to form small private groups via interconnected devices without a fixed network infrastructure. Moreover, encryption and authentication can readily be used between the Bluetooth-connected devices so that, by way of example, only a certain user's mobile station may be used in connection with a given portable computer. Using Bluetooth, therefore, it is possible to use a mobile station for the control of almost any device.

As is known, mobile stations can be used to carry out a variety of purchase and control transactions. A purchase transaction may for example consist of the selected payment, via the mobile station, for a product from an automated machine such as a vending machine. The growing range of services accessible through or associated with mobile stations, on the other hand, is a new area. The information to be communicated or transmitted is often of a nature that requires that it be accessible only to the sender and receiver, thus necessitating the provision of data security implemented, for example, by employing any of a variety of encryption methods.

Quite often the place to which it is necessary to transmit the data relating to a purchase or control transaction is not located in the vicinity of the actual place of performance of the purchase or control transaction. There accordingly arises the problem of transmitting the necessary information related to the transaction to a central system in a manner that maximizes ease and reliability. It is also necessary to be able, at the receiving end, to verify the absolute correctness of the information received and to verify or establish the identity of the sender.

At present, one unresolved problem in such arrangements and methods is how a service party's service apparatus and a given service produced by the apparatus should be addressed. Another existing problem is how the communication associated with the service transaction and its routing in a secure manner between the parties to the service transaction should be implemented.

### OBJECTS AND SUMMARY OF THE INVENTION

It is accordingly the desideratum of the present invention to eliminate, or at least significantly alleviate, the drawbacks and deficiencies of the prior art including, by way of example, those discussed hereinabove.

It is a particular object of the invention to provide a new type of method and system for addressing a service apparatus and a given service associated with the apparatus using a telecommunication terminal, preferably a mobile station.

Through application of the teachings of the present invention, a service request can be safely routed to a service provider. The present invention also provides a solution for global transmission of remittances from a telecommunication terminal to a payee.

The methods of the present invention provide for the secure routing of information and addressing of a service and of the parties to a service in a telecommunication system. The telecommunication system comprises a telecommunication terminal, a telecommunication network, a service provider connected to the telecommunication network and a service apparatus connected to the telecommunication network. There is also a communication link between the telecommunication terminal and the service apparatus.

In accordance with the inventive method, the telecommunication terminal functions as a selector of a desired service. The terminal, which in preferred implementations is a mobile station, is connected to the service apparatus via the communication link which may be implemented using Bluetooth technology. The communication link supports or accommodates the required use of encryption to prevent transmitted information in a useful form from getting into the hands of unintended outsiders. Where for example Bluetooth technology is employed in the communication link, a one-time identifier is assigned to the connection during connection setup for associating the intercommunicating parties with each other. Alternatively, the communication link may for example comprise an infrared link. The information to be transmitted can be encrypted by means of the telecommunication terminal, such as the preferred mobile station, in which case the actual encryption of the transmitted information may for example be performed by means of or within a subscriber identity module which contains the keys required for encryption and/or digital signing of the information.

The service apparatus receives the encrypted message from the telecommunication terminal. Part of the message may consist of a service provider's network address as determined by the terminal. The network address may also be determined in the service apparatus when it is known which service is intended to be accessed by the user. Based on the determined network address, the message is transmitted to the service provider. The network address is preferably an IP (Internet Protocol) address, which does not actually define the receiving machine but, rather, unambiguously or uniquely defines the connection within the world. It should also be understood that although the telecommunication network is described herein as the Internet, this network identification is solely by way of illustrative example and it is fully contemplated and intended that the telecommunication network in accordance with the invention may alternatively be any desired or otherwise available or suitable network, such as a bank payment network.

In the inventive method, the telecommunication terminal and/or the service apparatus and/or the service provided by the service apparatus is assigned an unambiguous identifier. This identifier may be associated with predetermined encryption and/or signing keys. In implementing encryption, the information received from the telecommunication terminal is encrypted and/or digitally signed using the keys associated with the service apparatus and/or the service-specific unambiguous identifier, and the encrypted and/or signed information is transmitted or sent over the telecommunication network to the service provider to a network address determined by the telecommunication terminal or service apparatus. When the service provider receives the encrypted message, the keys needed for its decryption can be determined on the basis of the identifier that forms a part of the message. In practice, the implementation may be such that the service provider and/or service apparatus communicates with a trusted third party (TTP), as via the telecommunication network. The trusted third party maintains a database containing the encryption and/or signing keys that are associated with each unambiguous identifier.

From the trusted third party, the service provider receives information regarding the keys associated with a given identifier, preferably public encryption and digital signing keys. The service apparatus may also communicate with the trusted third party. Where the encryption and/or digital signing of the message are implemented using a public key method, the authenticity of the message can be reliably verified. And based on the identifier, the service apparatus and/or service with which the identifier is associated can be determined. The service apparatus may, by way of example, be a cash machine, a cash system, a computer or an automated service machine.

The encryption of incoming and outgoing messages and the management of encryption keys, preferably public and secret or private keys of a public-private encryption key system, that are associated with the messages may be implemented using a specific security module. Through the use of such a security module it is possible to readily add the ability to use encryption and message authentication to equipment in which these features were not originally available.

The selected service may comprise response and/or control information from the service provider to the service apparatus and/or telecommunication terminal. The service apparatus can be controlled on the basis of a response sent by the service provider. Moreover, updating information about the progress of the service can be sent to the terminal, as for example where a telecommunication terminal is used as a means of payment, in which case a service request is sent from the terminal to the service provider and the service provider informs the terminal of the success or failure of the service request. Payment arrangements may additionally comprise a feature requiring that the payment transaction be separately confirmed; confirmation may for example be implemented by having the telecommunication terminal send a service-specific confirmation code in a separate message to the service provider. The separate message may by way of illustration take the form of an encrypted SMS (Short Message Service) message. Upon successful interpretation of the received SMS message, the service provider may send to the service apparatus a message or indication reflecting its permission to carry out the service.

One example of the protocol that may be used for communications or transmissions between the telecommunication terminal and the service provider is WAP (Wireless Application Protocol). The WAP protocol defines a standard for applications that provide services to terminals in a wireless network. Using the WAP protocol, for example, a telephone connection to a WWW (World Wide Web) server can be established. In addition, WML (Wireless Markup Language), which is the descriptive language of the WAP protocol, can be used in conjunction with a WAP implementation of the present invention. WML is a descriptive language that resembles HTML (HyperText Markup Language) but is specially adapted for a wireless environment.

Systems implemented in accordance with the present invention include means for providing a telecommunication terminal with an unambiguous terminal-specific identifier, means for addressing a given service apparatus using a telecommunication terminal by sending from the telecommunication terminal a predetermined connection setup request to the service apparatus, means for providing the service apparatus and/or the service mediated by the service apparatus with the unambiguous service-specific identifier, the identifier being associated with predetermined encryption and/or signing keys, and means for sending the service provider's network address and other information relating to the selected service from the telecommunication terminal to the service apparatus via a communication link.

The inventive system may further include means for addressing a given service apparatus using a telecommunication terminal by sending from the telecommunication terminal a predetermined connection setup request to the given service apparatus via a communication link. It may additionally include means for encrypting and/or signing the information received from the telecommunication terminal using keys associated with the service-specific and/or service apparatus-specific identifier, and means for sending encrypted and/or signed information to the service provider via the telecommunication network at a network address determined by the telecommunication terminal and/or service apparatus.

The system of the present invention may further include means for controlling the service apparatus on the basis of information sent by the service provider, and means for sending confirmation and/or other information from the service provider to the service apparatus and/or to the telecommunication terminal. It may also include means for sending a message confirming the service transaction from the telecommunication terminal to the service provider if a predetermined condition is fulfilled, and means for accepting the required service request only when the service apparatus receives from the service provider a confirmation code confirming the service transaction. The inventive system may additionally include means for encrypting the communication.

The system of the present invention may also include a trusted third party which communicates with the service apparatus and/or the service provider over the telecommunication network. The service provider and/or service apparatus may include means for sending to the trusted third party an inquiry relating to the encryption and/or signing keys that are associated with each unambiguous identifier.

The present invention provides and yields many advantages. Through use of the invention, a given service apparatus associated with a service, a given service mediated by the service apparatus and a given telecommunication terminal can be addressed. The invention also makes it possible to individuate the service provider associated with a selected service and to send to the service provider encrypted information relating to the service. For the user, a significant advantage is the resulting low cost of the available services. For example, since the inventive method does not necessarily require the setup of a connection for which a charge may be rendered by the operator, the cost to the user of utilizing the service is low. Additional reductions in user costs in accordance with the invention result from the use of an existing data network, i.e. the Internet, for the necessary communications between the service apparatus and the service provider.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a diagrammatic block diagram of a preferred system in accordance with the present invention; and

FIG. 2 is a flow chart depicting the inventive method and the operation of a preferred system of the invention.

### DETAILED DESCRIPTION OF THE CURRENTLY PREFERRED EMBODIMENTS

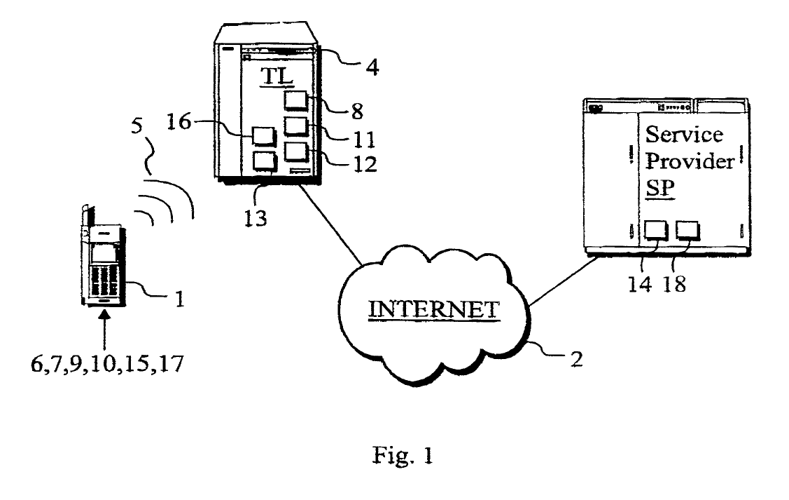

A currently-preferred system implementation in accordance with the present invention is shown in FIG. 1 and includes a telecommunication terminal 1, a service apparatus 4 and a service provider SP. The telecommunication terminal 1 is connected to the service apparatus 4 via a telecommunication link 5. The telecommunication terminal 1 is preferably a mobile station, and the communication link 5 may for example be a connection based on Bluetooth technology. The service apparatus 4 and service provider SP are connected to a telecommunication network 2 which, in preferred forms of the invention, is the global Internet network. Alternatively, the telecommunication network 2 may by way of illustrative, but noninclusive, example be a bank payment network. The preferred use of the Internet is particularly advantageous since the network covers a very large area and devices attached to the network can be unambiguously or uniquely identified.

The intended receiver of a service request is indicated using a network address that is set by means of the telecommunication terminal 1 or the service apparatus 4; in the particular implementations herein shown and described by way of preferred example, the address is an IP address, by virtue of which the receiver of the service request that is being sent is unambiguously defined.

The service provider SP identifies the sending service apparatus 4 by a globally unambiguous identifier that is included in the received message. That identifier individuates the message decryption keys associated with the identifier. In addition, based on that identifier, the service provider SP is able to send the service apparatus 4 a response, if necessary, to the service request. For each service apparatus-specific identifier, the service provider SP knows an unambiguous network address.

The telecommunication terminal 1 includes a means 6 for providing the terminal with a terminal-specific unambiguous identifier, and a means 7 for addressing a given service apparatus by sending, from terminal 1 to the service apparatus 4, a predetermined connection setup request. Using a means 9, the service provider's network address and/or other information relating to the service is sent to the service apparatus 4 via the communication link 5. Using a means 10, a given service apparatus 4 is addressed via the communication link 5. The telecommunication terminal 1 additionally includes a means 15 for sending a confirmation message confirming the service transaction to the service provider SP. Using a means 17, the communication 5 can be encrypted.

The service apparatus 4 includes a means 8 for providing the service apparatus and/or the service mediated by the service apparatus with an unambiguous identifier, and the identifier is associated with predetermined encryption and/or digital signing keys. Using a means 11, the information received by service apparatus 4 from telecommunication terminal 1 is encrypted using the keys associated with the service-specific and/or service apparatus-specific identifier. By way of a means 12 of the service apparatus, the encrypted information is sent via the telecommunication network 2 to the service provider SP. The service apparatus 4 additionally includes a means 13 for controlling the service apparatus 4 on the basis of information sent by service provider SP. By way of a means 16 of the service apparatus, the required service is only accepted when the service apparatus 4 receives from the service provider SP a confirmation code for the service transaction.

The service provider SP includes a means 14 for sending confirmation and/or other information to the service apparatus 4 and/or the telecommunication terminal 1. Using a means 18 of the service provider, a query requesting the encryption and/or digital signing keys associated with each unambiguous identifier is sent to a trusted third party.

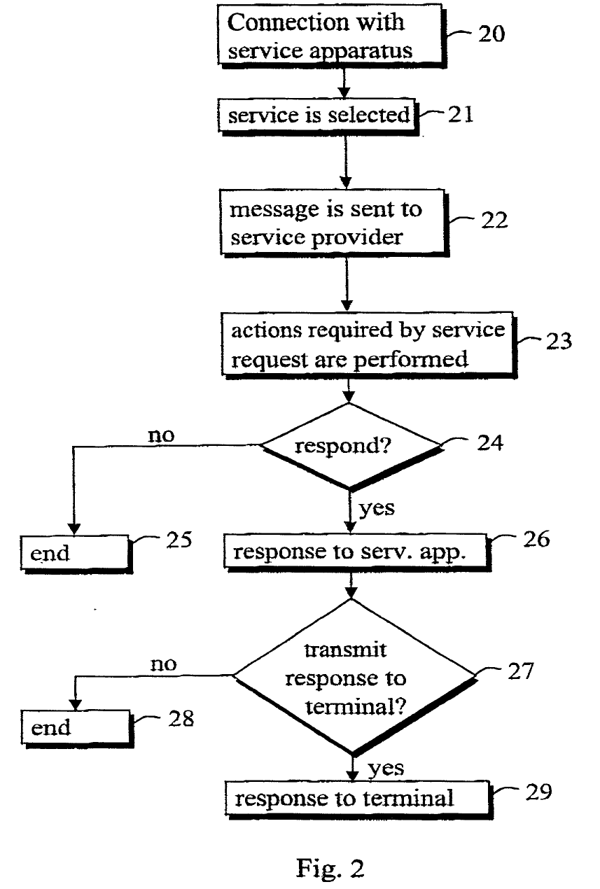

FIG. 2 is a flow chart depicting the process steps in a preferred implementation of the inventive method. Initially, at block 20, the user-client establishes a communication connection to a service apparatus of the user's selection; this communication connection, between the user's terminal and the service apparatus, may for example be established via a Bluetooth-based wireless link. At block 21, the client selects a desired service and the associated parameters by means of his terminal; the service may for example be the payment of a bill at the cash desk of a store. A service request is then sent (block 22) via the communication link to the service apparatus. A communication connection using Bluetooth technology includes encryption of the communication. After all of the information required for the service has been received from the telecommunication terminal, the operations required by or for implementing the service are carried out, as indicated at block 23.

For the service apparatus and/or the service mediated by the service apparatus, an unambiguous identifier linking a given service apparatus and the associated encryption keys has previously been defined. Based on this identifier, the service provider is able to identify the source of the message. The telecommunication terminal or the service apparatus adds the required network address to the message to be sent. The service apparatus encrypts the message and sends it to the service provider over a telecommunication network. In this particular illustrative example, the telecommunication network may be a bank payment network.

Using the decryption keys associated with the identifier, the service provider decrypts the received message. In order to ensure effective management of keys, a database of the identifiers and associated decryption keys is maintained, as for example by a trusted third party. Where the service request concerns a payment or monetary transfer at a cash desk as mentioned above, the service provider may be a bank. Depending on the particular service, a decision is made (block 24) as to whether a confirmation of the execution of the service is to be sent. If the service is of a nature that requires no response, then the process terminates (block 25). Where, on the other hand, a response is appropriate, the service provider sends to the service apparatus (block 26) and/or the telecommunication terminal (block 27) an encrypted response to the service request. The service provider encrypts the message with its own secret signing key and then encrypts the entire message using a public encryption key associated with the service apparatus; the service apparatus possesses (or otherwise has access to) the required decryption keys for deciphering of the message and digital signature. Confirmation of execution of the service transaction can also be sent to the telecommunication terminal (block 29). In the illustrative implementation herein discussed, the response or confirmation message sent may consist of or include information indicating that a bill was successfully paid. As shown in FIG. 2, however, a message confirming execution of the service need not necessarily be sent to the telecommunication terminal (block 28).

In the specific but nonetheless illustrative implementation of the inventive system depicted in FIG. 1, the subject service may be a cash or payment service. In such a system each cash register terminal in the store is provided with communication equipment consistent with or implementing Bluetooth technology. In addition, the terminal equipment of the client that wishes to use the cash service, in this case by way of example a mobile station, has the capability of using or being adapted for use with Bluetooth communication. The client wishes to pay for his shopping using a Bluetooth interface. Since the maximum range of a Bluetooth connection varies from ten meters to a few tens of meters, depending on the particular circumstances, there may be several cash register terminals within the current location of the mobile station that are capable of receiving the Bluetooth radio or wireless signals; the client therefore needs to individuate or identify the cash register terminal with which a connection is to be established. Bluetooth technology includes encryption of radio communication, so that information can be securely transferred via the wireless link. The mobile station may for example individuate the selected cash register terminal by sending a signal containing the number or other identification symbol of that particular cash register terminal. The connection is assigned a temporary identifier by which the communicating parties identify each other. Alternatively, the mobile station may contain an electronic component that is identified by the cash register terminal when the mobile station is moved to within a sufficiently short distance from the cash register terminal.

Using the Bluetooth link, the cash register terminal sends the information that it has received about the requested service to the service provider. The service provider in this example is a bank. This service information may for example include the account to be charged, service provider address data, the sum to be charged and other information relevant to the particular service and/or transaction. The service provider is individuated by means of a predetermined defined network address which may be included in the information present or stored in the mobile station prior to the service transaction; alternatively, the network address may be determined by the cash register terminal. The information transmitted between the cash register terminal and the service provider is encrypted to prevent its unintended interception and misuse by others, using encryption keys specific to the service apparatus and/or service. The service provider possesses or has access to the keys required for decryption of the transmitted information.

The user of the service may be required to confirm the service request if the amount to be paid exceeds a certain limit, such as $50. To provide that confirmation, the service provider sends to the mobile station, via the cash register terminal, a confirmation reference which the mobile station must return to the service provider, as for example in an SMS message. The user thus includes the confirmation code in the message, encrypts and/or digitally signs the message, and sends the encrypted message to the service provider. The service provider decrypts that message from the user and thereby verifies the identity of the user and interprets the information contained in the message. The service provider then sends to the user a message indicating successful remittance of the payment, for example using the Bluetooth link via the cash register terminal.

Another illustrative implementation using the inventive system depicted in FIG. 1 contemplates client refueling of a vehicle in an automated gas or refueling station in which, for example, the client wishes to refill the fuel tank of a company car. The company car has been fitted with a Bluetooth-based communication device. When the car arrives at the filling location, the communication device establishes a radio connection with the automated filling machine. The communication device in the car contains identifying information that includes, by way of example, the account of the company and the network address of the service provider (e.g. bank). The client confirms the payment transaction using a predetermined identifier, thereby ensuring that a person illicitly using the car will be unable to refuel the vehicle on the company's account. Communication between the automated filling machine and the service provider is encrypted using an encryption key associated with the filling machine. The service provider transmits a response message to the filling machine, which forwards it on to the communication device in the client's company car.

While there have shown and described and pointed out fundamental novel features of the invention as applied to preferred embodiments thereof, it will be understood that various omissions and substitutions and changes in the form and details of the methods described and the systems and devices illustrated, and in their operation, may be made by those skilled in the art without departing from the spirit of the invention. For example, it is expressly intended that all combinations of those elements and/or method steps which perform substantially the same function in substantially the same way to achieve the same result are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. A method for secure routing of information and addressing of a service and of parties to the service in a telecommunication system that includes a telecommunication terminal, a telecommunication network, a service provider connected to the telecommunication network, a service apparatus connected to the telecommunication network for mediating the service, and a communication link connecting the telecommunication terminal and the service apparatus, said method comprising the steps of:
providing the telecommunication terminal with a terminal-specific unambiguous identifier;
addressing the service apparatus from the telecommunication terminal by sending a predetermined connection setup request from the telecommunication terminal to the service apparatus;
providing at least one of the service apparatus and the service mediated by the service apparatus with a service-specific unambiguous identifier associated with predetermined keys for at least one of encryption and digital signing; and
sending one of a network address of the service provider and information relating to the mediated service from the telecommunication terminal to the service apparatus via the communication link.

2. A method in accordance with claim 1, wherein the service apparatus is addressed from the telecommunication terminal by sending the predetermined connection setup request from the telecommunication terminal to the service apparatus via the communication link.

3. A method in accordance with claim 1, further comprising the step of one of encrypting and digitally signing information sent from the telecommunication terminal using the keys associated with the service-specific unambiguous identifier, and wherein said sending step comprises sending the one of encrypted and digitally signed information from the telecommunication terminal to the service provider using an address determined by the telecommunication terminal.

4. A method in accordance with claim 1, wherein the service apparatus is controlled based on information sent by the service provider.

5. A method in accordance with claim 1, further comprising the step of sending, from the service provider to one of the service apparatus and the telecommunication terminal, a confirmation message.

6. A method in accordance with claim 1, further comprising the step of sending, from the service provider to one of the service apparatus and the telecommunication terminal, a confirmation message confirming a service transaction if a predetermined condition has been fulfilled.

7. A method in accordance with claim 1, further comprising the step of sending, from the service provider to one of the service apparatus and the telecommunication terminal, an SMS message confirming a service transaction.

8. A method in accordance with claim 1, wherein a service request from the telecommunication terminal is accepted only after the service apparatus has received from the service provider a confirmation code for a requested service transaction.

9. A method in accordance with claim 1, wherein the communication link comprises a Bluetooth communication connection.

10. A method in accordance with claim 1, wherein the communication link comprises an infrared communication connection.

11. A method in accordance with claim 1, wherein the communication link is encrypted.

12. A method in accordance with claim 1, further comprising the step of using a public-private key encryption system for one of encrypting and digitally signing information exchanged between at least two of the telecommunication terminal, the service apparatus and the service provider.

13. A method in accordance with claim 1, wherein WAP is used in communications between the telecommunication terminal and one of the service apparatus and the service provider.

14. A method in accordance with claim 1, wherein the service provider communicates with a trusted third party that maintains a database containing one of encryption and digital signing keys associated with the unambiguous identifiers.

15. A method in accordance with claim 1, further comprising the step of sending a request, from one of the service provider and the service apparatus to a trusted third party that maintains a database containing one of encryption and digital signing keys associated with the unambiguous identifiers, a request for the keys.

16. A method in accordance with claim 1, wherein the network address is an IP address.

17. In a telecommunication system that includes a telecommunication terminal, a telecommunication network, a service provider connected to the telecommunication network, a service apparatus connected to the telecommunication network for mediating a service, and a communication link connecting the telecommunication terminal and the service apparatus, the improvement comprising a system for secure routing of information and addressing of the service and of parties to the service, said system comprising:
means for providing the telecommunication terminal with a terminal-specific unambiguous identifier;
means for addressing the service apparatus from the telecommunication terminal by sending a predetermined connection setup string from the telecommunication terminal to the service apparatus;
means for providing at least one of the service apparatus and the service mediated by the service apparatus with a service-specific unambiguous identifier associated with predetermined keys for at least one of encryption and digital signing; and
means for sending one of a network address of the service provider and information relating to the mediated service from the telecommunication terminal to the service apparatus via the communication link.

18. The system of claim 17, further comprising means for addressing the service apparatus from the telecommunication terminal by sending the predetermined connection setup request from the telecommunication terminal to the service apparatus via the communication link.

19. The service of claim 17, further comprising:
means for at least one of encrypting a digitally signing information sent from the telecommunication terminal using the keys associated with the service-specific unambiguous identifier; and
means for sending the at least one of encrypted and digitally signed information over the telecommunication network to a network address determined by one of the telecommunication terminal and the service apparatus.

20. The system of claim 17, further comprising means for controlling the service apparatus based on information sent by the service provider.

21. The system of claim 17, further comprising means for sending, from the service provider to one of the service apparatus and the telecommunication terminal, a confirmation message.

22. The system of claim 17, further comprising means for sending, from the service provider to one of the service apparatus and the telecommunication terminal, a confirmation message confirming a service transaction if a predetermined condition has been fulfilled.

23. The system of claim 17, further comprising means for only accepting a service request from the telecommunication terminal after the service apparatus has received from the service provider a confirmation code for a requested service transaction.

24. The system of claim 17, further comprising means for encrypting the communication link.

25. The system of claim 17, further comprising a trusted third party that communicates with one of the service apparatus and the service provider over the telecommunication network.

26. The system of claim 17, wherein one of the service provider and the service apparatus comprises means for sending to a trusted third party a request for the one of the encryption and digital signing keys associated with the unambiguous identifier.

27. The system of claim 17, wherein the telecommunication terminal comprises a mobile station having a connected subscriber identity module.

28. The system of claim 17, wherein the service apparatus comprises an automated teller machine.

29. The system of claim 17, wherein the service apparatus comprises a cash register system.

30. The system of claim 17, wherein the service apparatus comprises a computer.

31. The system of claim 17, wherein the service apparatus comprises an automated service machine.

32. The system of claim 17, wherein the telecommunication network comprises the Internet.

33. The system of claim 17, wherein the telecommunication network comprises a bank payment network.
